(19) United States
(12) Patent Application Publication
(10) Pub. No.: US 2006/0098012 A1
(43) Pub. Date: May 11, 2006

(54) Apparatus and method for processing image with reduced memory capacity and power consumption

(76) Inventor: Hyun-Sang Park, Cheonan-si (KR)

Correspondence Address: LAW OFFICE OF MONICA H CHOI, P O BOX 3424, DUBLIN, OH, 430160204, US

(21) Appl. No.: 11/151,151

(22) Filed: Jun. 13, 2005

(30) Foreign Application Priority Data
Nov. 10, 2004 (KR) 2004-91505

(51) Int. Cl. G06T 11/20

(52) U.S. Cl. 345/441

(57) ABSTRACT

For converting image data into a block scan order with an h*v sized block, a memory stores a respective n-pixel data segment at each address with n=h. An address generator determines a current address of the memory for a current n-pixel data segment of a previous phase to be read according to the block scan order, and for subsequently storing another n-pixel data segment for a next phase. By reading/writing n-pixel data segments for each read/write cycle in one line memory, memory capacity and power consumption are minimized.

### BACKGROUND OF THE INVENTION

This U.S. non-provisional patent application claims priority under 35 U.S.C. §119 to Korean Patent Application No. 2004-91505 filed on Nov. 10, 2004, the entire contents of which are incorporated herein by reference.

1. Field of the Invention

The present invention relates generally to image processing, and more particularly, to an apparatus and method for converting image data from raster scan order to block scan order with reduced memory capacity and power consumption.

2. Background of the Invention

As well known, JPEG (Joint Photographic Experts Group) image processing uses discrete cosine transform (DCT) for image data compression. In DCT compression, image data is processed in blocks with each block being for 8*8 pixels. On the other hand, an image processor of a camera outputs image data in a raster scan order (i.e., a raster scanning sequence which scans an image in sequential lines from left to right and from top to bottom).

Line memory storing image data of at least eight lines is used for converting image data from the raster scan order to the block scan order. In addition, as one line memory is used for such conversion, the image processor of the camera continues to output additional image data in raster scan order. Thus, in the prior art, another line memory is used to store such additional image data. Image data is typically composed of a luminance component (Y) and chrominance components (U and V), and two line memories are used for each of such components.

FIG. 1 shows a block diagram of a prior art image processing apparatus having a line memory system for the luminance component (Y). In FIG. 1, the luminance component for the first eight-lines of pixels are output from a camera processor 10 and then stored in a first line memory 20, in raster scan order. As the luminance component for a next eight-lines of pixels are stored in a second line memory 40 in raster scan order, luminance components are read out from the first line memory 20 in a block scan order for 8*8 pixel blocks. In addition, a multiplexer 50 transfers the luminance components in 8*8 pixel blocks from the first line memory 20 to a JPEG engine 60 under control of an address generator 30. The address generator 30 outputs write and read addresses for the line memories 20 and 40.

FIG. 2 illustrates image data from the camera processor 10 being written in a line memory in a raster scan order, and FIG. 3 illustrates such image data being read out from the line memory in the block scan order. In FIGS. 2 and 3, the number of horizontal pixels is 640 and the number of vertical pixels (i.e., the number of lines) is 480. One line memory stores image data for 640*8 pixels corresponding to 8 lines of pixels. Assuming that one pixel data is composed of 8 bits, the size of the line memory is 640*8*8. Although the present invention is described for the VGA (video graphics array) standard, the present invention may be practiced with different line memory size depending on the image resolution.

Referring back to FIG. 1, write addresses for the line memories 20 and 40 are incremented from 0 to 640*8-1. A write address waddr is incremented in raster scan order whenever image data for a pixel is output from the camera processor 10 in sync with a system clock signal.

A read address raddr of the memories 20 and 40 for reading the image data there—from in block scan order is determined by an Algorithm1 as follows (written in C programming language):

[Algorithm1]

```
imax = 640<<3;
parity = 0;
for (i = 0; i<640; i++){
    waddr = 0;
    for(v=0; v<8; v++){
        for(h=0; h<8; h++){
            raddr = v*640+i = i*8+h;
            dout = M[parity][raddr];
            M[˜parity][waddr] = din;
            waddr++;
        }
    }
    parity = ˜parity;
}
```

The write addresses M[0][ ] and M[1][ ] denote the line memories 20 and 40 to be accessible in the unit of 8 bits.

Alternatively, the read address raddr may be obtained also by a following Algorithm2 (written in C programming language):

[Algorithm2]

```
imax = 640<<3;
parity = 0;
for (i = 0; i<imax; i++){
    waddr = 0;
    for(v=0; v<8; v++){
        addrp = (v*80+i){
        for(h=0; h<8; h++){
            raddr = addrp+h;
            dout = M[parity][raddr];
            M[˜parity][waddr] = din;
            waddr++;
        }
    }
parity = ˜parity;
}
```

Here, the parameters i, v, and h represent a scanning order of blocks, an horizontal scanning order in a block, and a vertical scanning order in a block, respectively.

In such prior art, two line memories are used for each component of image data. For example in the VGA standard, two line memories, each of size 640*8 bytes, are used for processing the luminance component (Y). Such multiple line memories increase a chip size, especially as image size increases.

U.S. Patent Application Publication No. 2004/0096108 discloses an image processing apparatus that converts image data from the raster scan order to the block scan order using a single line memory. However, this prior art reference processes image data for one pixel at a time which increases power consumption.

### SUMMARY OF THE INVENTION

Accordingly, the present invention processes image data with reduced line memory capacity and reduced power consumption.

For converting image data into a block scan order with an h*v sized block in an aspect of the present invention, a memory stores a respective n-pixel data segment at each address with the n-pixel data segment being comprised of data for n-pixels with n=h. In addition, an address generator determines a current address of the memory for a current n-pixel data segment of a previous phase to be read from the memory according to the block scan order. Furthermore, the memory device stores another n-pixel data segment for a next phase in the current address of the memory.

In another embodiment of the present invention, a divider separates the n-pixel data segment for the previous phase into data bits for the n separate pixels that are sent to an image processing engine.

In an example embodiment of the present invention, the image processing engine is a JPEG (Joint Photographic Expert Group) engine. In that case, the h*v sized block is an 8*8 sized block.

In a further embodiment of the present invention, a packer receives data bits for n separate pixels for the next phase from a camera processor in a raster scan order. The packer then packs the data bits for the n separate pixels for the next phase into the n-pixel data segment for the next phase.

In an example embodiment of the present invention, the camera processor is for capturing an image of H*V pixels, and the memory has capacity for storing data bits for H*v pixels.

In this manner, the data segment comprised of image data for h pixels for h*v blocks are read or written at a time for one read/write cycle for minimized read and write operations. With such minimized read and write cycles, power consumption is reduced. Furthermore, just one line memory is used for converting image data from the raster scan order to the block scan order for minimized memory capacity.

### BRIEF DESCRIPTION OF THE DRAWINGS

The above and other features and advantages of the present invention will become more apparent when described in detailed exemplary embodiments thereof with reference to the attached drawings in which:

FIG. 1 illustrates an image processing apparatus using two line memories, according to the prior art;

FIG. 2 illustrates writing image data into a line memory from a camera processor in a raster scan order;

FIG. 3 illustrates reading image data from the line memory in a block scan order;

FIG. 4 is a block diagram of an image processing system according to an embodiment of the present invention;

FIG. 5 illustrates example image data in accordance with a VGA (video graphic array) standard;

FIG. 6 illustrates an arrangement of pixels and data segments in a phase of FIG. 5;

FIG. 7 illustrates an example embodiment of a line memory of FIG. 4;

FIG. 8 shows a structure of image data output from a camera processor of FIG. 4;

FIGS. 9A, 9B, 9C, and 9D illustrate memory addresses for data segments written into the line memory of FIG. 4 for multiple phases of FIG. 8, according to an embodiment of the present invention;

FIGS. 10A and 10B show timing diagrams of signals during reading and writing of the data segments from and into the line memory of FIG. 4, according to an embodiment of the present invention; and

FIG. 11 shows a flow-chart of steps during operation of the image processing system of FIG. 4 for converting image data of a raster scan order to a block scan order, according to an embodiment of the present invention.

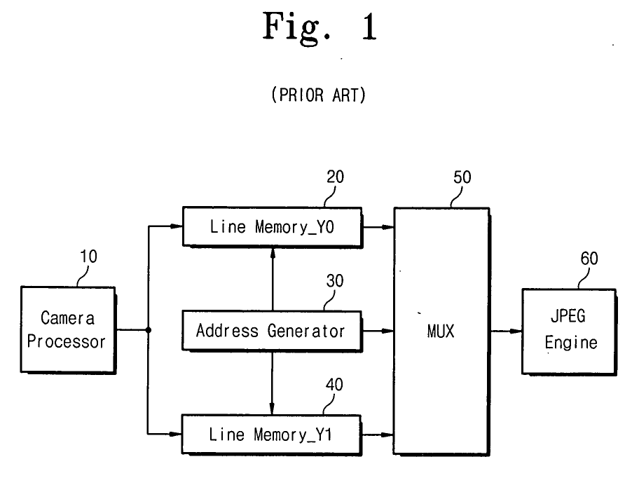

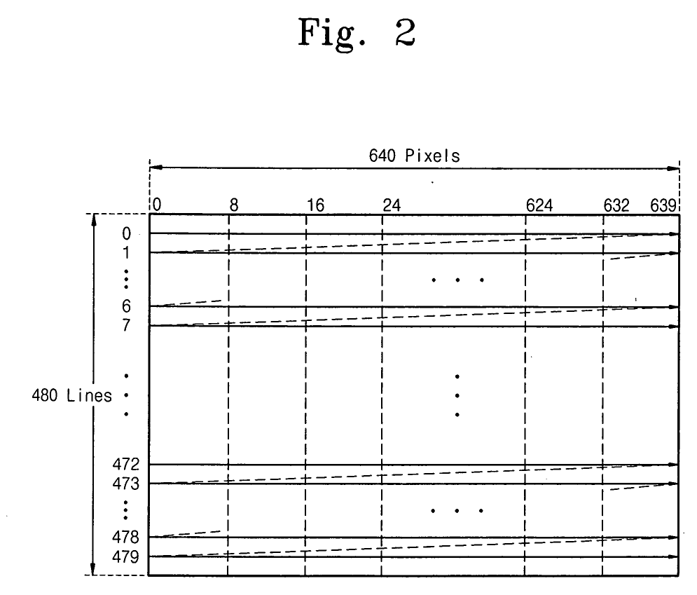

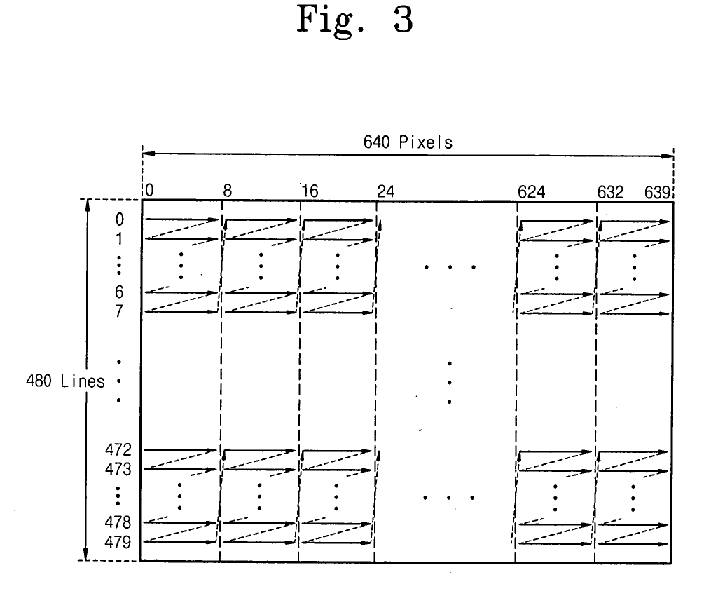

The figures referred to herein are drawn for clarity of illustration and are not necessarily drawn to scale. Elements having the same reference number in FIGS. 1, 2, 3, 4, 5, 6, 7, 8, 9A, 9B, 9C, 9D, 10A, 10B, and 11 refer to elements having similar structure and/or function.

### DETAILED DESCRIPTION OF THE INVENTION

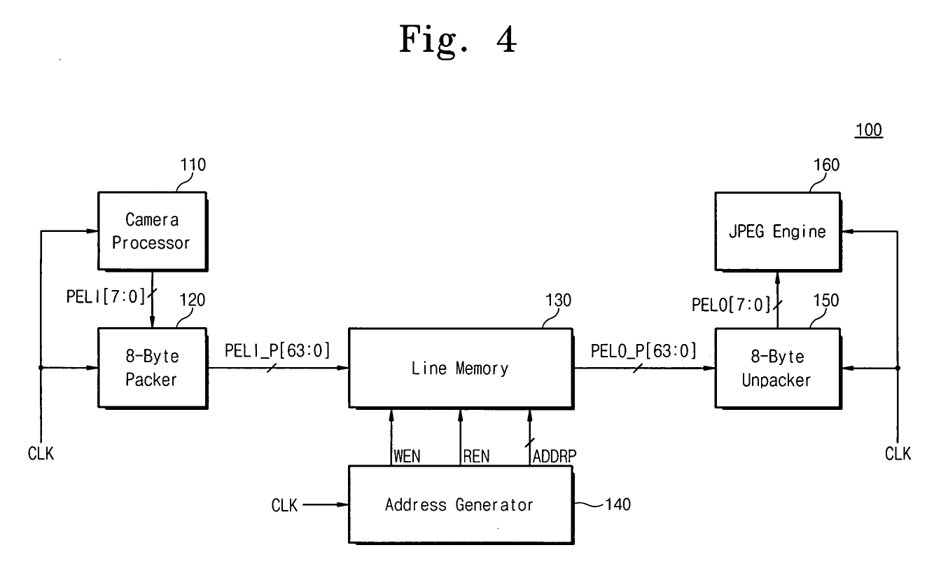

FIG. 4 is a block diagram of an image processing system 100 according to an embodiment of the present invention. Referring to FIG. 4, the image processing system 100 is comprised of a camera processor 110, a packer 120, a line memory 130, an address generator 140, an unpacker 150, and a JPEG engine 160. The image data is basically composed of a luminance component (Y) and chrominance components (U and V), but FIG. 4 shows the one line memory 130 for processing just the luminance component (Y) for convenience of description.

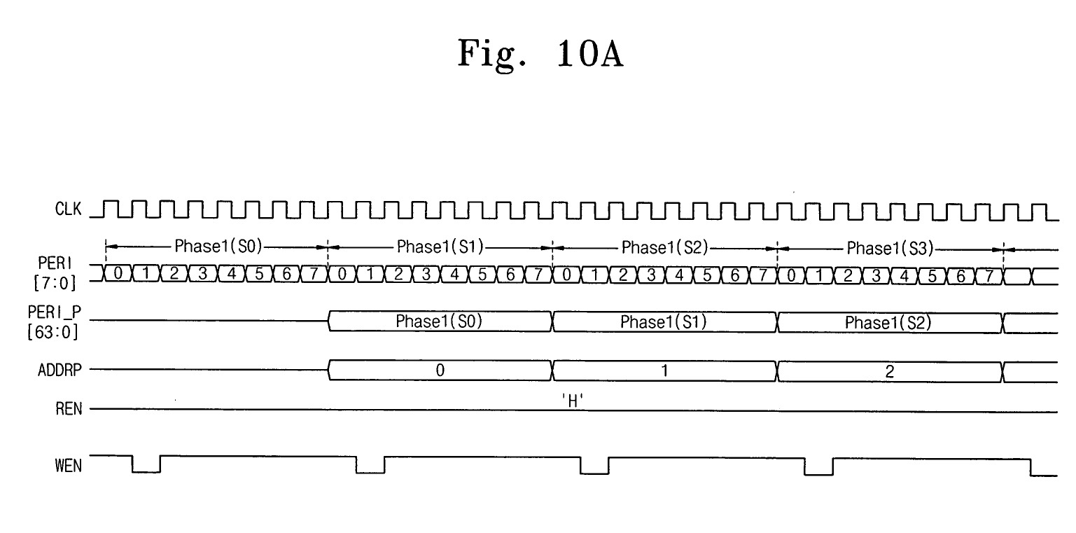

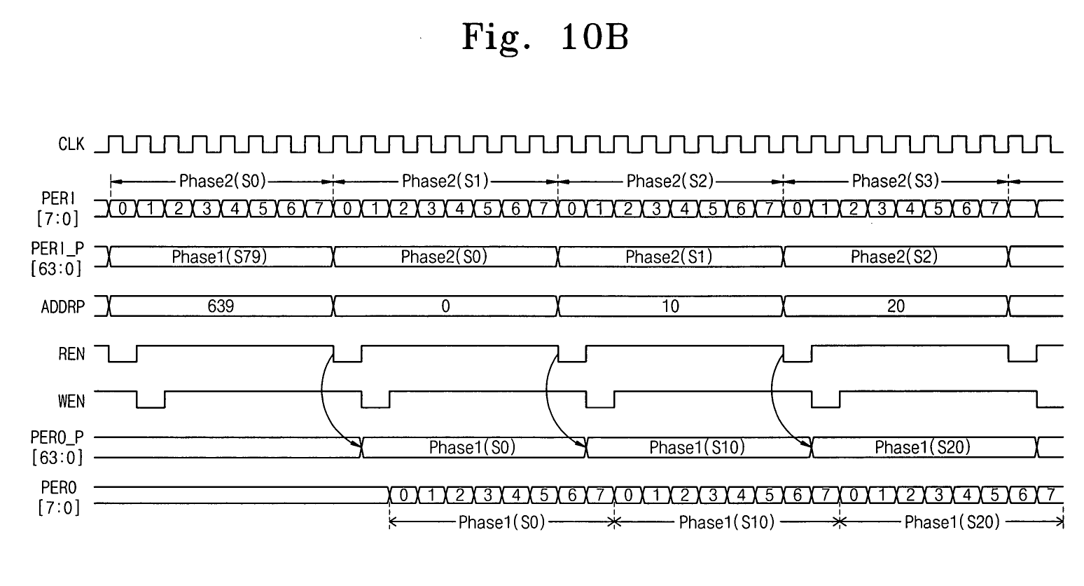

The camera processor 110 outputs image data (the luminance component for example) in a raster scan order synchronized to a clock signal (CLK in FIGS. 10A and 10B). Such image data is stored in the line memory 130. Assume that the resolution of the image is H*V and that the JPEG engine 160 processes image data in units of an h*v sized block. In that case, the line memory 130 has capacity for at least H*v bytes. For example, if the resolution of the camera processor 110 is 640*480 and if the JPEG engine 160 is for the VGA standard, H=640, V=480, and h=v=8.

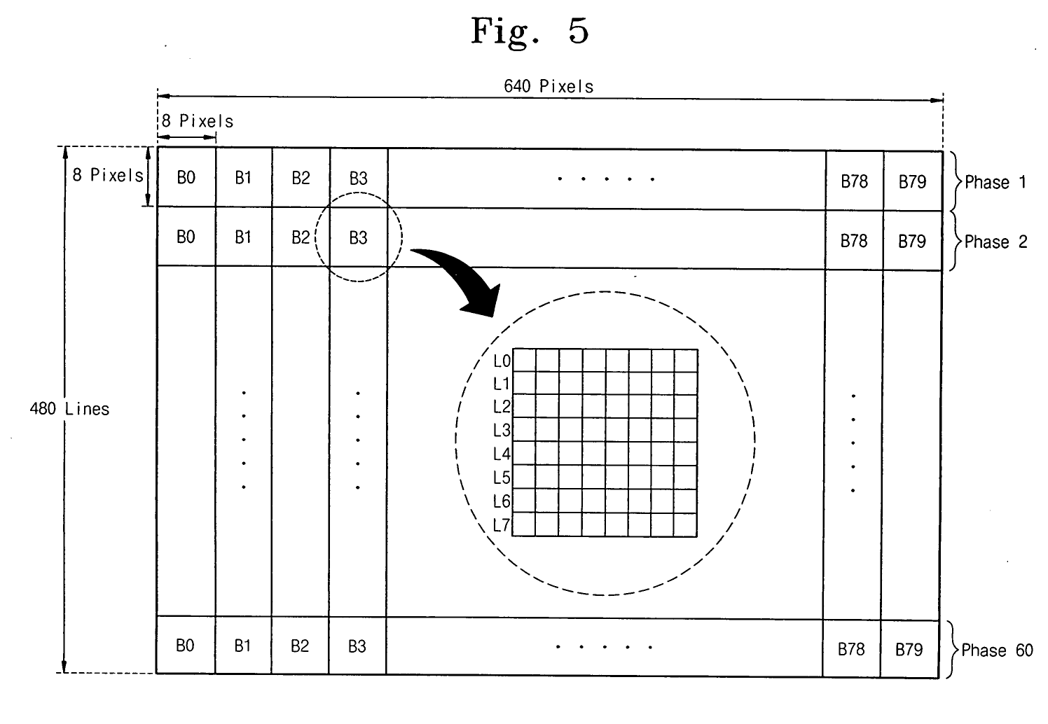

FIG. 5 illustrates an example frame of image data in accordance with the VGA standard. One frame is constructed of 640 pixels in the horizontal direction and 480 pixels in the vertical direction, (i.e., 640*480=307,200 pixels). The line memory 130 of FIG. 4 has capacity for storing image data of 640*8 pixels. One frame contains 480/8=60 phases, Phase1, Phase2, . . . , and Phase60. Image data of one phase is able to be stored in the line memory 130 at the same time. The JPEG engine 160 processes image data in the unit block of 8*8 pixels. Further referring to FIG. 5, each phase is segmented into 80 blocks B0, B1, . . . , and B79.

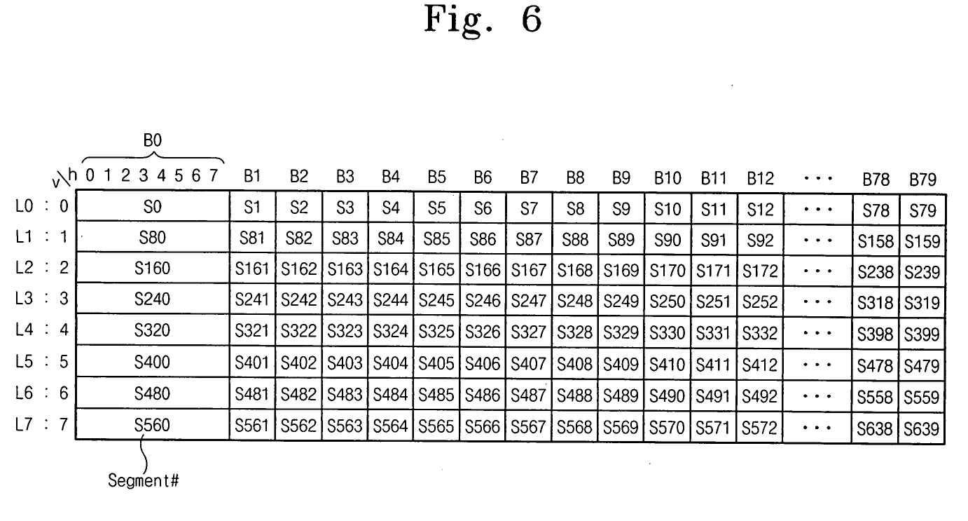

FIG. 6 illustrates an arrangement of data segments in a phase of FIG. 5. One block is for 8 pixels along the row direction by 8 pixels in the column direction including for the eight lines L0, L1, . . . , and L7. Hereinafter, the image data for eight consecutive pixels along a line is referred to as a “data segment.” Therefore, one block includes eight data segments down along the column direction, and one phase includes 640 data segments S0, S1, . . . , and S639.

Referring back to FIG. 4, the camera processor 110 provides 8-bits of image data PELI[7:0] for each pixel to the packer 120 in sync with a clock signal CLK. The packer 120 combines image data for 8 pixels from the camera processor 110 into one data segment PELI_P[63:0] comprised of 64-bits. The 8-pixel data segment PELIP[63:0] generated by the packer 120 corresponds to the image data for the h-pixels within one line of an h*v block. The line memory 130 stores the data segment PELI_P[63:0] from the packer 120 in one address ADDRP of the line memory 130, in response to a write enable signal WEN and the address signal ADDRP.

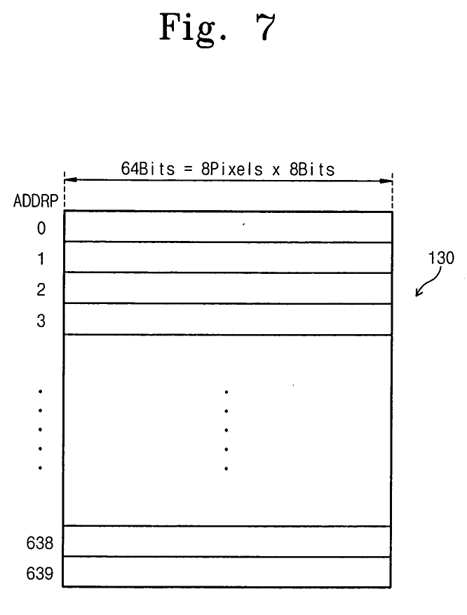

FIG. 7 shows an example embodiment of the line memory 130 of FIG. 4. In FIG. 7, the line memory 130 has 640 addresses indicated by the address signal ADDRP which varies from 0 to 639. The data width of each address is 8*8=64 bits. Thus, the line memory 130 has capacity for storing 8*8*640 bits for the 80 blocks in a phase of FIG. 6.

The line memory 130 outputs an 8-pixel data segment PELO_P[63:0] stored at an address ADDRP in response to a read enable signal REN and the address signal ADDRP. The data segments output from the line memory 130 are arranged in the block scan order. The unpacker 150 separates the 8-pixel data segment PELO_P[63:0] into eight separate pixel data, with each pixel data comprised of 8-bits PELO[7:0] that is provided to the JPEG engine 160 for further processing.

The address generator 140 outputs a write enable signal WEN, and a read enable signal REN, and the address signal ADDRP. In one embodiment of the invention, read and write addresses for the line memory 130 are identical to each other. In other words, after reading image data from the address ADDRP of the line memory 130, different image data is subsequently stored into that same address ADDRP. In detail, the address generator 140 is a data processor that performs the following Algorithm3 for generating the address signal ADDRP (in C programming language):

[Algorithm3]

```
no_hor_bk = 640 >> 3;
no_size = (no_hor_bk << 3) − 1;
block_offset = 1;
line_offset = no_hor_bk;
while (!finished) {
    for (i=0; i<no_hor_bk; i++){
        for (v=0; v<8; v++){
            addrp= (block_offset*i + line_offset*v) % no_size;
            if (v==7 && i=no_hor_bk − 1) addrp = no_size;
            dout_pack = M[addrp]; din_pack = 0;
            for (h=0; h<8; h++){
            dout = dout_pack[63:56];
            din_pack = {din_pack << 8, din};
        }
        M[addrp] = din_pack;
    }
    block_offset = line_offset;
    line_offset = (line_offset * no_hor_bk) % no_size;
}
```

Here, the parameters addrp, i, and v denote the address signal ADDRP, a block index, and a vertical pixel index (i.e., line index), respectively. The parameter no_hor_bk represents the number of blocks belonging to one phase, H/h=640/8, and the parameter no_size represents the number of horizontal pixels. In Algorithm3, an address signal may be generated for frames of a different size by using another value aside from the example of 640.

Such an Algorithm3 generates the address signal ADDRP in a block scan order after the 8-pixel data segments PELI_P[63:0] are stored in the line memory 130 in the raster scan order. Image data for a frame of 80*32 pixels is now described for simplicity of description and illustration.

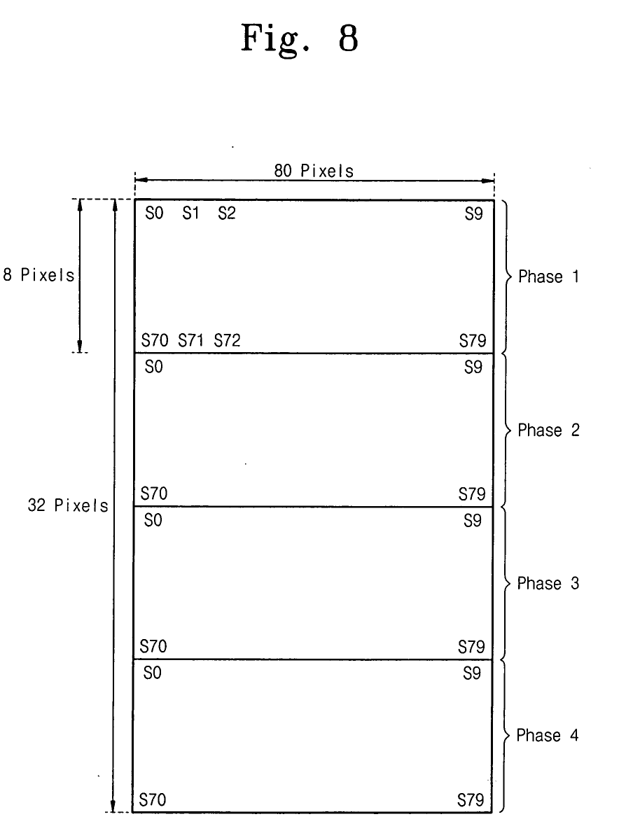

FIG. 8 shows a structure of image data output from the camera processor 110 assuming a resolution of the camera processor 110 to be 80*32 pixels. In that case, the line memory 130 has capacity for storing image data of 80*8 pixels, and one frame includes four phases Phase1, Phase2, Phase3, and Phase4. Each phase includes 80 segments S0, S1, . . . , and S79. Each data segment has image data for 8 pixels. The number-label after the “S” for each segment indicates the order as output from the camera processor 110 in the raster scan order.

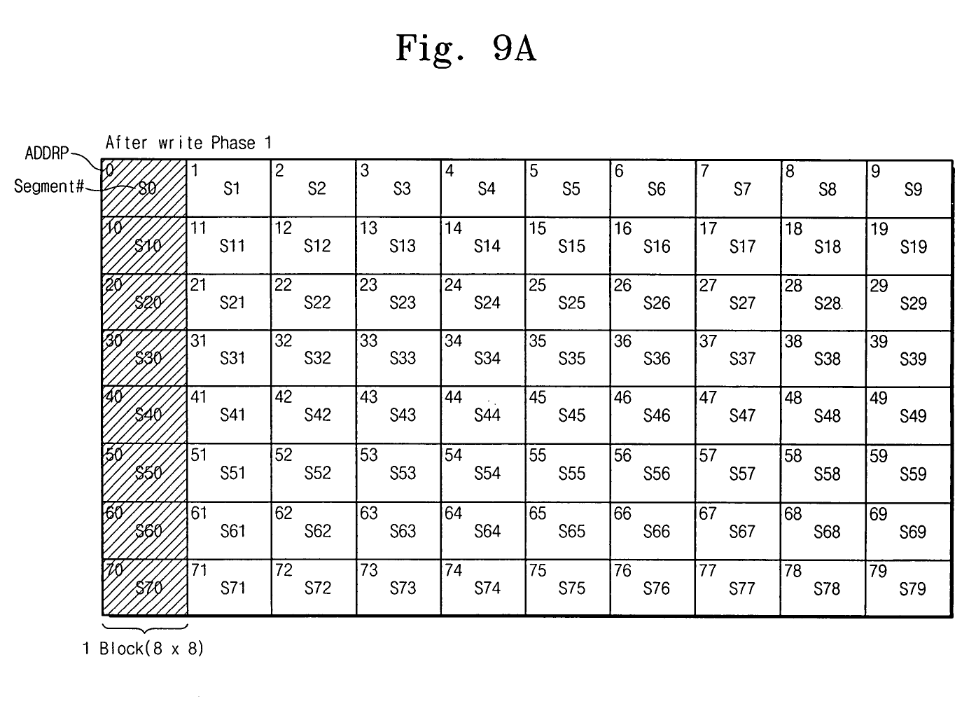

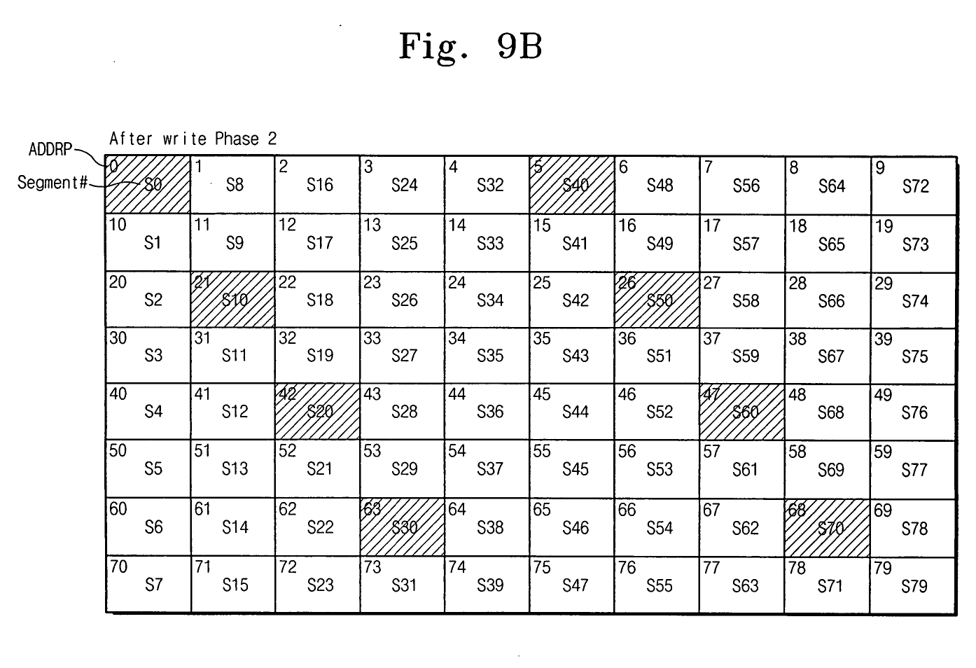

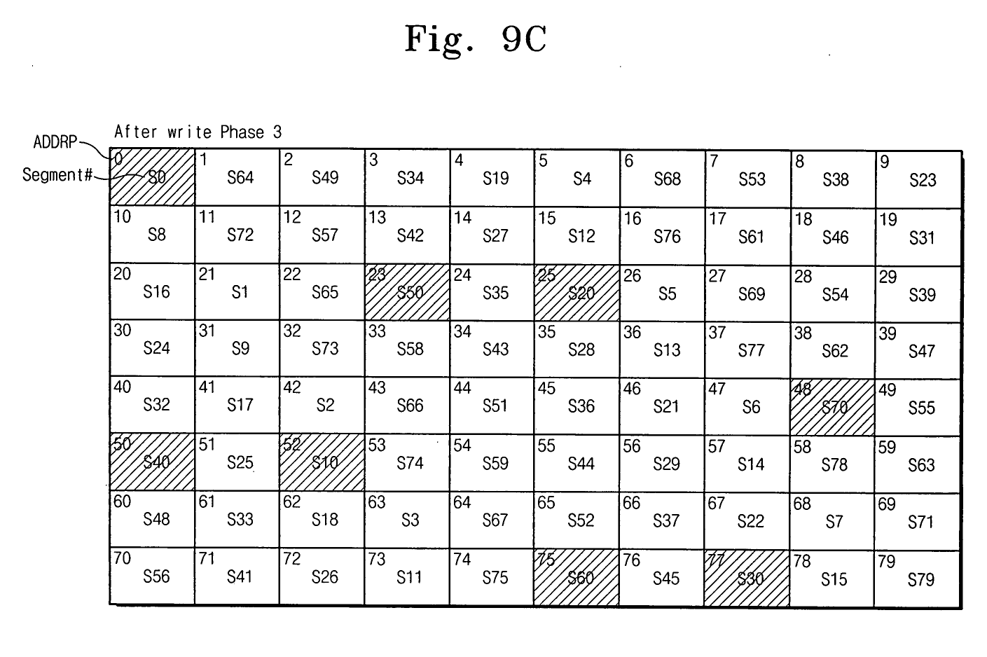

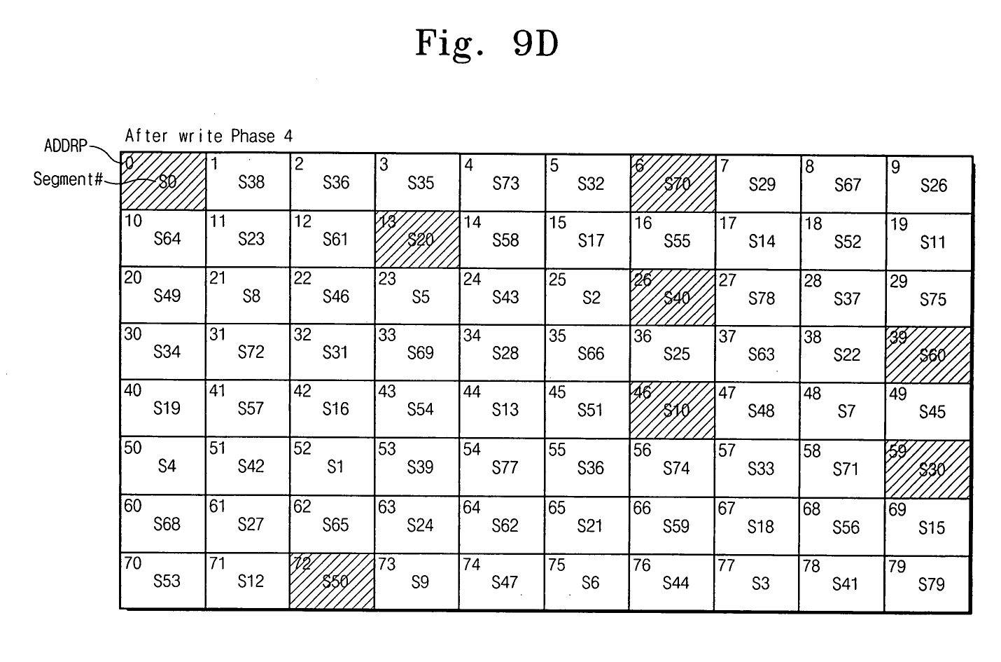

FIGS. 9A, 9B, 9C, and 9D illustrate memory addresses for data segments written into the line memory of FIG. 4 for multiple phases of FIG. 8, according to an embodiment of the present invention. FIGS. 10A and 10B show timing diagrams of signals during reading and writing of the data segments from and into the line memory of FIG. 4, according to an embodiment of the present invention.

FIG. 9A illustrates storing the data segments for the first phase Phase1 in the line memory 130. The packer 120 generates each data segment PELI_P[63:0] from combining the 8-bit pixel data PELI[7:0] for 8-pixels consecutively output from the camera processor 110 in the raster scan order. Referring to FIGS. 9A and 10A, the packer 120 outputs each data segment PELI_P[63:0] generated every 8-cycles of the clock signal CLK.

In FIG. 10A, the address generator 140 activates the write enable signal WEN and updates the address signal ADDRP, every 8-cycles of the clock signal CLK. The algorithm for generating the address signal ADDRP is according to the Algorithm3 above for example. For the first phase of FIG. 9A, the address signal ADDRP from the address generator 140 is updated in the raster scan order of 0, 1, 2, 3, . . . , 78, and 79.

The line memory 130 stores each of the data segments S0, S1, S2, . . . , and S78, and S79 in each of the addresses 0, 1, 2, 3, . . . , 78, and 79, respectively, at every activation of the write enable signal WEN. In FIG. 9A, the shaded data segments are for a first block (for 8*8 pixels) to be read out in the block scan order. Thus, in the block scan order, the first block of data segments is read out in the order of S0, S10, S20, . . . , and S70. Then, the second block of data segments is read out in the order of S1, S11, S21, . . . , and S71, and so on until the tenth block of data segments is read out.

In FIGS. 9A, 9B, 9C, and 9D, the number label at the upper left corner indicates an address of the line memory 130. Referring to FIGS. 9A, 9B, and 10B, each time an 8-pixel data segment of Phase1 (a previous phase) is read out from a current address ADDRP of the line memory 130 with activation of the read enable signal REN, another 8-pixel data segment of Phase2 (a next phase) is thereafter written into that same current address ADDRP of the line memory 130 with activation of the write enable signal WEN.

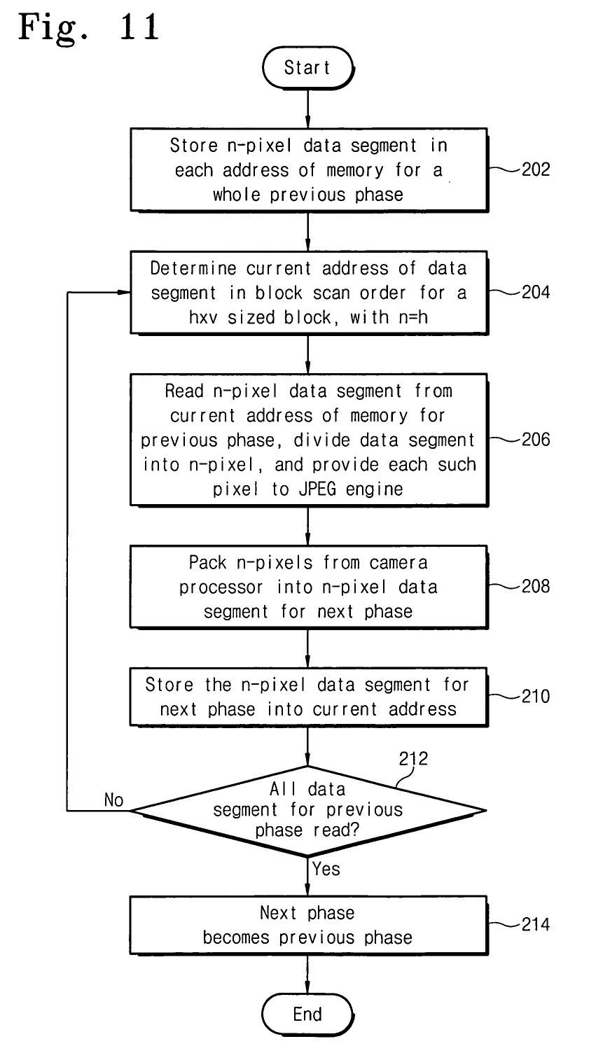

FIG. 11 shows a flowchart of steps during operation of the image processing system 100 of FIG. 4. Referring to FIGS. 9 and 11, a respective 8-pixel data segment has been stored in each address of the line memory 130 for all of Phase1 (the previous phase) in raster scan order according to the timing diagram of FIG. 10A (step 202 of FIG. 11).

Thereafter, the address generator 140 determines a current address ADDRP of the line memory 130 to be accessed in a block scan order for the 8*8 sized block (step 204 of FIG. 11). Referring to FIGS. 9A, 9B, 10B, and 11, the address generator 140 activates the read enable signal REN such that the line memory 130 reads out the 8-pixel data segment PELO_P[63:0] from the current address (step 206 of FIG. 11). In addition, the unpacker 150 divides the 64-bits of such an 8-pixel data segment PELO_P[63:0] into individual 8-bits PELO[7:0] of image data for eight separate pixels that are sent to the JPEG engine 160 for further processing (step 206 of FIG. 11).

Furthermore, the packer 120 continuously receives 8-bits PELI[7:0] of image data from the camera processor 110 and packs together such bits for 8-pixels to result in the 64-bits of another 8-pixel data segment PELI_P[63:0] for the next phase Phase2 (step 208 of FIG. 11). Such an 8-pixel data segment PELI_P[63:0] for the next phase Phase2 is written into the current address ADDRP of the line memory 130 during activation of the write enable signal WEN after the 8-pixel data segment PELO_P[63:0] for the previous phase Phase1 has been read out from that same address during prior activation of the read enable signal REN (step 210 of FIG. 11). In the embodiment of FIG. 10B, such a write enable signal WEN is activated during a subsequent cycle of the clock signal CLK after activation of such a read enable signal REN.

Thereafter, if all 8-pixel data segments for the previous phase Phase1 have not yet been read out from the line memory 130, steps 204, 206, 208, 210, and 212 of FIG. 11 are repeated for each subsequent address of the line memory in the block scan order until all 8-pixel data segments for the previous phase Phase1 are read out from the line memory 130. At that point, the line memory 130 stores all 8-pixel data segments for the next phase Phase2 (as illustrated in FIG. 9B). In addition, at that point, the next phase Phase2 becomes the previous phase and another subsequent phase Phase3 becomes the next phase.

Thereafter, steps 204, 206, 208, 210, and 212 of FIG. 11 are repeated with the address generator 140 determining an order of the current address ADDRP such that the 8-pixel data segments for the previous phase Phase2 are read from the line memory 130 in the block scan order. For example, the shaded portions in FIG. 9B show the location of the 8-pixel data segments for a first block in the line memory 130. In that case, the address generator 140 generates ADDRP in the order of 0, 21, 42, 63, 5, 26, 47, and then 68 for reading the data segments for such a first block. Thus, the order of the addresses ADDRP generated by the address generator 140 is different for the second phase Phase2 than for the first phase Phase1.

FIG. 9C illustrates the contents of the line memory 130 after all 8-pixel data segments for the second phase Phase2 have been read out from the line memory 130 and after new 8-pixel data segments for the next phase Phase3 have been written into the line memory 130. FIG. 9D illustrates the contents of the line memory 130 after all 8-pixel data segments for the third phase Phase3 have been read out from the line memory 130 and after new 8-pixel data segments for the next phase Phase4 have been written into the line memory 130.

In this manner, the order of the addresses ADDRP generated by the address generator 140 for reading out data segments is different for each phase, since data segments are stored into such addresses ADDRP in different order for each phase. In addition, steps 204, 206, 208, 210, 212, and 214 of FIG. 11 are repeated for each previous phase and next phase, until power down of the image processing system 100 or until the camera processor 110 no longer provides any image data.

Algorithm3 above generates such addresses ADDRP in the block scan order. Alternative algorithms for also generating the addresses ADDRP in block scan order are shown an Algorithm4 and Algorithm5 in the following (in C programming language):

[Algorithm 4]

```
no_hor_bk = 640 >> 3;
no_size = (no_hor_bk << 3) − 1;
block_offset = 1;
line_offset = no_hor_bk;
while (!finished) {
    block_number = 0;
    for (i=0; i<no_hor_bk; i++){
        line_number = 0;
        for (v=0; v<8; v++){
            addrp= (block_number + line_number);
            if (addrp>=no_size) addrp −= no_size;
            if (v==7 && i=no_hor_bk − 1) addrp = no_size;
            dout_pack = M[addrp]; din_pack = 0;
            for (h=0; h<8; h++){
                dout = dout_pack[63:56];
                din_pack = {din_pack << 8, din};
                dout_pack = dout_pack << 8;
            }
            M[addrp] = din_pack;
            line_number += line_offset;
            if (line_number >= no_size) line_number −= no_size;
        }
        block_number += block_offset;
        if (block_number >= no_size) block_number −= no_size;
    }
    block_offset = line_offset;
    line_offset = (line_offset * no_hor_bk) % no_size;
}
```

[Algorithm 5]

```
no_size = (no_hor_bk << 3) − 1;
block_offset = 1;
line_offset = no_hor_bk;
while (!finished) {
    addrp = 0;
    block_number = 0;
    for (i=0; i<no_hor_bk; i++){
        line_number = 0;
        for (v=0; v<8; v++){
            if (addrp>=no_size) addrp −= no_size;
            if (v==7 && i=no_hor_bk − 1) addrp = no_size;
            dout_pack = M[addrp]; din_pack = 0;
            for (h=0; h<8; h++){
                dout = dout_pack[63:56];
                din_pack = {din_pack << 8, din};
                dout_pack = dout_pack << 8;
            }
            M[addrp] = din_pack;
            line_number += line_offset;
            If (line_number >= no_size) line_number −= no_size;
            addrp = (block_number + line_number);
            if (addrp >= no_size) block_number −= no_size;
        }
        block_number += block_offset;
        if (block_number >= no_size) block_number −= no_size;
    }
    block_offset = line_offset;
    line_offset = (line_offset * no_hor_bk) % no_size;
}
```

The Algorithm3 above uses three multipliers, while the Algorithm4 uses no multipliers. Furthermore, Algorithm5 is amenable for generating the addresses ADDRP in block scan order with efficient hardware implementation.

In this manner, the 8-pixel data segment comprised of image data for 8-pixels within a line of an 8*8 block is read/written for each read/write cycle for minimized read and write operations. With such minimized read and write operations, power consumption is reduced. Furthermore, just one line memory 130 is used for converting image data from the raster scan order to the block scan order for minimized memory capacity.

The foregoing is by way of example only and is not intended to be limiting. For example, any numbers used herein such as the number of pixels, block size, line memory size, or image resolution size are by way of example only. The present invention is limited only as defined in the following claims and equivalents thereof.

What is claimed is:

1. A method of converting image data into a block scan order with an h*v sized block, comprising:
A. determining a current address of a memory for an n-pixel data segment according to the block scan order, with the n-pixel data segment being comprised of data for n-pixels with n=h;
B. reading the n-pixel data segment from the current address of the memory for a previous phase; and
C. storing another n-pixel data segment for a next phase in the current address of the memory.

2. The method of claim 1, further comprising:
dividing the n-pixel data segment for the previous phase into data bits for the n separate pixels; and
sending the data bits for the n separate pixels to an image processing engine.

3. The method of claim 2, wherein the image processing engine is a JPEG (Joint Photographic Expert Group) engine.

4. The method of claim 3, wherein the h*v sized block is an 8*8 sized block.

5. The method of claim 1, further comprising:
receiving data bits for n separate pixels for the next phase from a camera processor in a raster scan order; and
packing the data bits for the n separate pixels for the next phase into the n-pixel data segment for the next phase.

6. The method of claim 1, further comprising:
repeating steps A, B, and C for each subsequent n-pixel data segment to be read from the memory in the block scan order until all n-pixel data segments for the previous phase are read from the memory.

7. The method of claim 1, further comprising:
repeating steps A, B, and C for reading n-pixel data segments from the memory for the next phase and for writing n-pixel data segments for a subsequent next phase, when all n-pixel data segments for the previous phase have been read from the memory.

8. The method of claim 1, further comprising:
storing in the memory all n-pixel data segments for a first phase in a raster scan order before the step A.

9. An apparatus for converting image data into a block scan order with an h*v sized block, comprising:
a memory for storing a respective n-pixel data segment at each address with the n-pixel data segment being comprised of data for n-pixels with n=h; and
an address generator for generating a current address of the memory for a current n-pixel data segment of a previous phase to be read from the memory according to the block scan order;
wherein the memory device stores another n-pixel data segment for a next phase in the current address of the memory.

10. The apparatus of claim 9, further comprising:
a divider for dividing the n-pixel data segment for the previous phase into data bits for the n separate pixels that are sent to an image processing engine.

11. The apparatus of claim 10, wherein the image processing engine is a JPEG (Joint Photographic Expert Group) engine.

12. The apparatus of claim 11, wherein the h*v sized block is an 8*8 sized block.

13. The apparatus of claim 9, further comprising:
a packer for receiving data bits for n separate pixels for the next phase from a camera processor in a raster scan order, and for packing the data bits for the n separate pixels for the next phase into the n-pixel data segment for the next phase.

14. The apparatus of claim 13, wherein the camera processor is for capturing an image of H*V pixels, and wherein the memory has capacity for storing data bits for H*v pixels.

15. The apparatus of claim 9, wherein the memory stores all n-pixel data segments for a first phase in a raster scan order.

16. An image processing system, comprising:
a camera processor that generates pixel data for H*V pixels in a raster scan order;
an image processing engine that processes h*v sized blocks of pixel data in a block scan order;
a line memory for storing data for H*v pixels; and
means for reading a respective n-pixel data segment of a previous phase from each address the line memory with addresses of the line memory being sequenced according to the block scan order.

17. The image processing system of claim 16, further comprising:
means for writing a next n-pixel data segment for a next phase into an address of the line memory during a clock cycle after reading an n-pixel data segment of the previous phase from said address.

18. The image processing system of claim 17, further comprising:
a packer for receiving data bits for n separate pixels for the next phase from the camera processor in the raster scan order, and for packing the data bits for the n separate pixels for the next phase into the n-pixel data segment for the next phase.

19. The image processing system of claim 16, further comprising:
a divider for dividing the n-pixel data segment for the previous phase into data bits for the n separate pixels that are sent to the image processing engine.

20. The image processing system of claim 16, wherein the image processing engine is a JPEG (Joint Photographic Expert Group) engine, and wherein the h*v sized block is an 8*8 sized block.
